(19) United States
(12) Patent Application Publication
(10) Pub. No.: US 2009/0262265 A1
(43) Pub. Date: Oct. 22, 2009

(54) Display that can be assembled in a force-saving manner and method for assembling the display

(75) Inventors: Chun-Hong Kuo, Taipei Hsien (TW); Sheng-Chieh Yang, Taipei Hsien (TW); Chih-Wei Kuo, Taipei Hsien (TW)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: Wistron Corporation, Taipei Hsien (TW)

(21) Appl. No.: 12/269,940

(22) Filed: Nov. 13, 2008

(30) Foreign Application Priority Data
Apr. 18, 2008 (TW) 097206667
May 15, 2008 (TW) 097117837

(51) Int. Cl. H04N 5/64; B23P 11/00

(52) U.S. Cl. 348/836; 29/525.11; 348/E05.128

(57) ABSTRACT

A display that can be assembled in a force-saving manner includes a display body and a base. The display body includes a housing, a display module disposed within the housing, and at least one engaging portion. The housing has a bottom wall. The first engaging portion is provided on the bottom wall. The base includes a top wall for locking with the bottom wall, and a second engaging portion provided on the top wall and corresponding to the first engaging portion. The second engaging portion engages the first engaging portion so as to positioning the top wall of the base relative to the bottom wall of the display body to facilitate threaded locking there between. A method for assembling the display is also disclosed.

### CROSS-REFERENCE TO RELATED APPLICATION

This application claims priority of Taiwanese Application No. 097206667, filed on Apr. 18, 2008, and Taiwanese Application No. 097117837, filed on May 15, 2008.

### BACKGROUND OF THE INVENTION

1. Field of the Invention

The invention relates to a display and a method for assembling the display, more particularly to a display having a base threadedly locked thereto and a method for assembling the display.

2. Description of the Related Art

FIG. 1 shows a conventional display, which includes a display body 11 and a base 12 disposed below the display body 11. Aside from supporting the display body 11, the base 12 facilitates placement of the display body 11 on a planar surface. The coupling between the display body 11 and the base 12 is through threaded engagement. During threaded engagement, the display body 11 is laid flat, and the base 12 is held in such a manner that screw holes therein are aligned with screw holes in a bottom portion of the display body 11 for subsequent screwing operations. Without any positioning means, it would be laborious and time-consuming for an operator to hold the base 12 and perform the screwing operations simultaneously.

### SUMMARY OF THE INVENTION

Therefore, a object of the present invention is to provide a display that allows an operator to easily perform screwing operations in a time- and force-saving manner.

An other object of the present invention is to provide a method for assembling the aforesaid display.

Accordingly, a display that can be assembled in a force-saving manner of this invention comprises a display body and a base. The display body includes a housing, a display module disposed within the housing, and at least one first engaging portion. The housing has a bottom wall. The first engaging portion is provided on the bottom wall. The base includes a top wall disposed to be locked to the bottom wall, and a second engaging portion provided on the top wall and corresponding to the first engaging portion. The second engaging portion is disposed to engage the first engaging portion so as to enable the top wall of the base and the bottom wall of the display body to be positioned relative to each other to facilitate threaded locking there between.

According to a preferred embodiment of this invention, the first engaging portion is a hole, and the second engaging portion is an engaging tab for engaging the hole.

According to a preferred embodiment of this invention, the bottom wall includes an outer plate and an inner plate. The first engaging portion includes an opening provided in the outer plate, and a tab provided on the inner plate and accessible through the opening. The second engaging portion includes an engaging tab body and a retaining hole provided in the engaging tab body.

According to a preferred embodiment of this invention, the display body further includes a pair of positioning holes provided in the bottom wall. The base further includes a pair of guiding posts provided on the top wall of the base. The guiding posts extend respectively into the positioning holes when the base and the display body are coupled to each other.

According to a preferred embodiment of this invention, the display body further includes a plurality of first locking holes provided in the bottom wail, and the base further includes a plurality of second locking holes provided in the top wall. The first locking holes and the second locking holes correspond to each other for extension of a plurality of screws therethrough when the first engaging portion and the second engaging portion engage each other.

The method for assembling the display of the present invention comprises the following steps:

(A) allowing the display body to lie flat;

(B) bringing the second engaging portion of the base into engagement with the first engaging portion of the display body, and causing the top wall of the base to correspond to the bottom wall of the display body; and

(C) threadedly locking the top wall of the base to the bottom wall of the display body.

According to a preferred embodiment of this invention, the first engaging portion includes an opening provided in the bottom wall and a tab accessible through the opening, and the second engaging portion includes an engaging tab body provided on the top wall and a retaining hole provided in the engaging tab body. In step (B), the engaging tab body is extended into the opening, the retaining hole is brought to engage the tab, and the top wall of the base is positioned relative to the bottom wall of the display body for subsequent threaded locking there between.

According to a preferred embodiment of this invention, in step (B), when the engaging tab body is extended into the opening, the top wall of the base is displaced in a direction toward the bottom wall of the display body, and when the retaining hole engages the tab, the top wall of the base is displaced downward relative to the bottom wall of the display body.

The present invention utilizes the second engaging portion of the base to engage the first engaging portion of the display body, so that the base can be pre-attached to the display body, thereby sparing the operator the trouble of holding the base while performing screwing operations. This is not only more force-saving, the entire assembly process can be rendered more time-saving and more convenient.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional display;

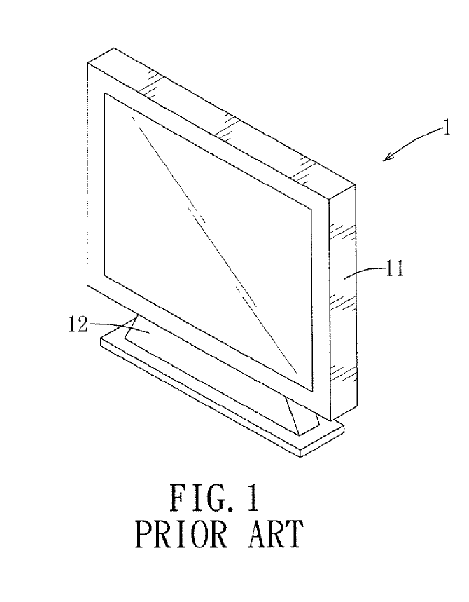

FIG. 2 is a partly exploded perspective view of a preferred embodiment of a display that can be assembled in a force-saving manner according to the present invention;

FIG. 3 is a perspective view of a base of the preferred embodiment;

FIG. 4 is a perspective partly cutaway view to illustrate engagement between the base and a display body of the preferred embodiment; and

FIG. 5 is a flow chart to illustrate a preferred embodiment of a method for assembling a display according to the present invention.

### DETAILED DESCRIPTION OF THE PREFERRED EMBODIMENT

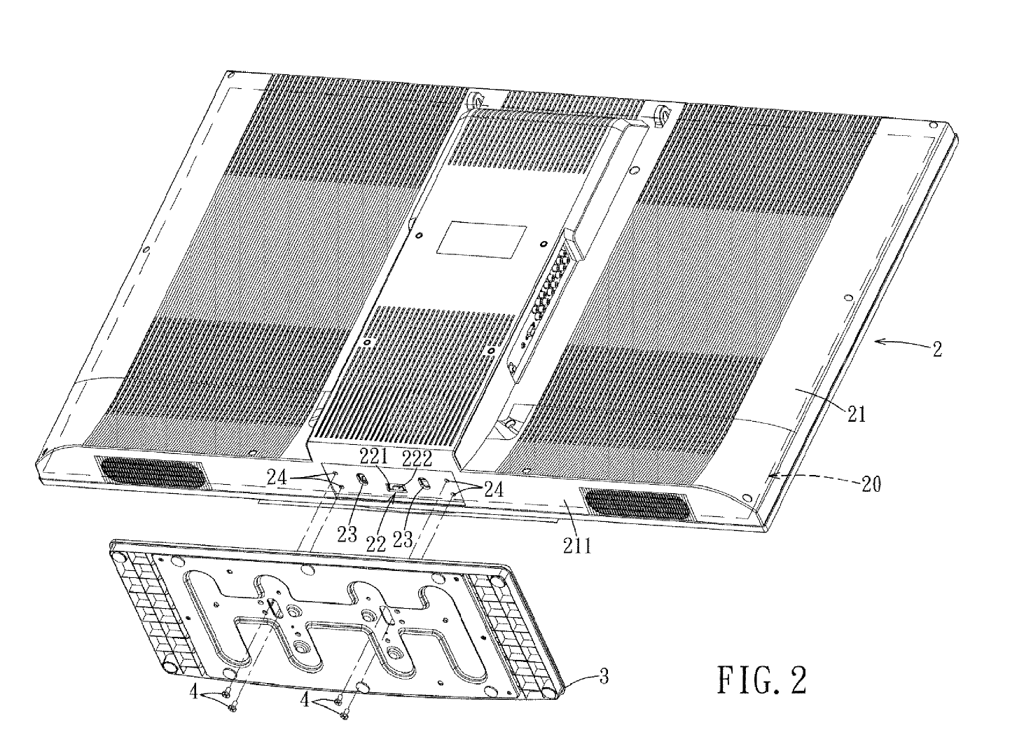

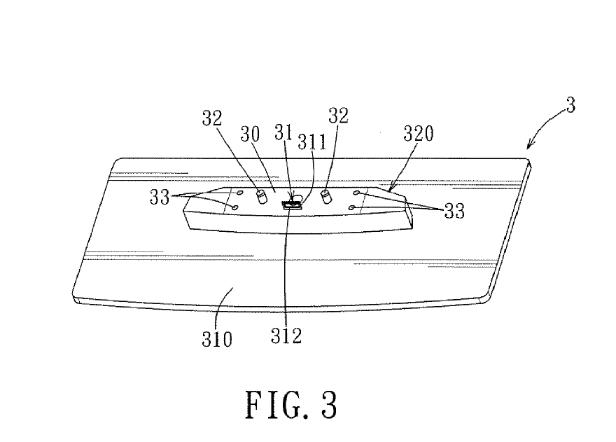

Referring to FIGS. 2 to 4, the preferred embodiment of a display that can be assembled in a force-saving manner according to this invention is shown to comprise a display body 2 and a base 3. The display may be a thin type display, such as a liquid crystal display or a plasma display.

The display body 2 includes a housing 21, a display module (not shown) disposed within the housing 21, and at least one first engaging portion 22. The housing 21 has a bottom wall 211. In this embodiment, the bottom wall 211 includes an outer plate 212 and an inner plate 213. The first engaging portion 22 is a hole disposed in the bottom wall 211, and includes an opening 221 provided in the outer plate 212, and a tab 222 provided on the inner plate 213. The tab 222 on the inner plate 213 is accessible through the opening 221 in the outer plate 212. In this embodiment, the tab 222 is defined by a U-shaped slot in the inner plate 213, and the tab 222 is parallel to the inner plate 213. In addition, the display body 2 of this embodiment further includes two positioning holes 23 provided in the bottom wall 211 and a plurality of first locking holes 24. The positioning holes 23 are through holes extending through the bottom wall 211. The first locking holes 24 are screw holes.

The base 3 includes a top wall 30, and a second engaging portion 31, a pair of guiding posts 32, and a plurality of second locking holes 33 provided in the top wall 30. In the structure of this embodiment, the base 3 has a chassis portion 310 and a support portion 320 that is formed to project from the chassis portion 310. The top wall 30 is disposed on the support portion 320. In this embodiment, the second engaging portion 31 is an engaging tab, and includes an engaging tab body 311 and a retaining hole 312 provided in the engaging tab body 311. The guiding posts 32 are formed to extend upward from the top wall 30. The second locking holes 33 are screw holes disposed in the top wall 30.

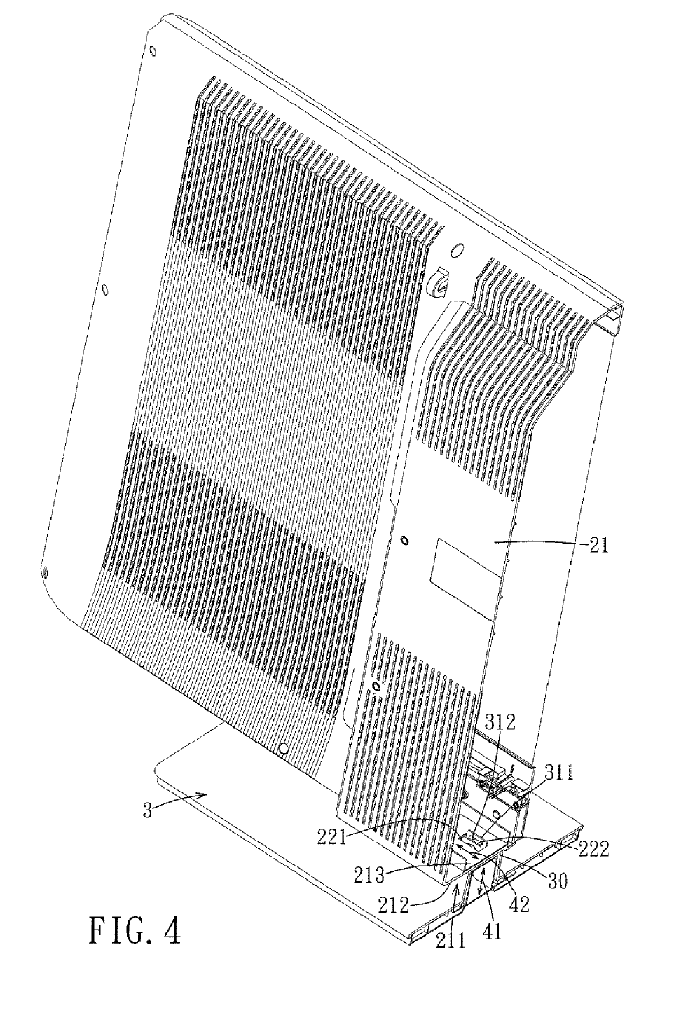

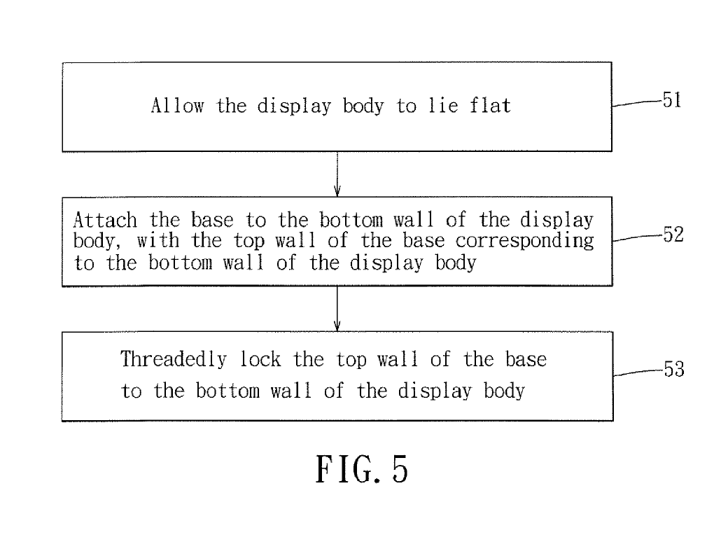

Referring to step 51 to step 53 in FIG. 5, and with further reference to FIG. 2 to FIG. 4, during assembly of the display body 2 and the base 3, the display body 2 is laid flat, with a distal end of the tab 222 of the first engaging portion 22 oriented upward. Next, the top wall 30 of the base 3 is moved toward the bottom wall 211 of the display body 2, such that the two guiding posts 32 respectively extend into the two positioning holes 23 in the bottom wall 211 of the display body 2, and such that the second engaging portion 31 is extended into the opening 221 in the display body 2. Subsequently, the retaining hole 312 in the engaging tab body 311 is brought to engage the tab 222, and the top wall 30 of the base 3 is displaced downwardly relative to the bottom wall 211 of the display body 2, thereby completing the engagement between the first and second engaging portions 22, 31. By means of the engagement between the first and second engaging portions 22, 31, the base 3 is restrained from displacing in a direction (as indicated by an arrow 41 in FIG. 4) substantially perpendicular to the bottom wall 211 of the display body 2, and leftward and rightward displacement of the base 3 relative to the display body 2 (as indicated by an arrow 42 in FIG. 4) is also limited, so that the bottom wall 211 of the display body 2 and the top wall 30 of the base 3 correspond and are positioned relative to each other. The base 3 can thus be attached to and positioned relative to the display body 2. Thereafter, screws 4 are extended through the second locking holes 33 in the base 3 and the first locking holes 24 in the display body 2 to thereby lock the base 3 onto the display body 2.

It is noted that the first and second engaging portions 22, 31 are not limited to what is disclosed in the preferred embodiment. The second engaging portion 31 may be a hook provided on the base 3, and the first engaging portion 21 may be a retaining hole provided in the display body 2. Alternatively, any other connecting or suspending structures that can couple the display body 2 and the base 3 together in a simple manner would be applicable. The purpose of the first and second engaging portions 22, 31 is to enable the base 3 to be temporarily positioned relative to the display body 2 prior to the screwing operation, thereby sparing the operator the trouble of holding the base 3 while performing the screwing operation. Certainly, the numbers and positions of the first and second engaging portions 22, 31 are not limited to what is disclosed in this preferred embodiment, and may be changed depending on the size of the display.

It is apparent from the foregoing that, in the present invention, the base 3 is pre-attached to the display body 2 by virtue of the engagement between the second engaging portion 31 provided on the base 3 and the first engaging portion 22 provided on the display body 2, so that the operator does not need to hold the base 3 during the screwing operation, or require any additional tools to position the base 3 relative to the display body 2, thereby rendering the entire assembly process not only more force-saving, but also more time-saving and more convenient.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A display that can be assembled in a force-saving manner, said display comprising:
a display body including a housing, a display module disposed within said housing, and at least one first engaging portion, said housing having a bottom wall, said first engaging portion being provided on said bottom wall; and
a base including a top wall disposed to be locked to said bottom wall, and a second engaging portion provided on said top wall and corresponding to said first engaging portion;
said second engaging portion being disposed to engage said first engaging portion so as to enable said top wall of said base and said bottom wall of said display body to be positioned relative to each other to facilitate threaded locking there between.

2. The display according to claim 1, wherein said first engaging portion is a hole, and said second engaging portion is an engaging tab for engaging said hole.

3. The display according to claim 2, wherein said bottom wall includes an outer plate and an inner plate, said first engaging portion including an opening provided in said outer plate, and a tab provided on said inner plate and accessible through said opening, said second engaging portion including an engaging tab body and a retaining hole provided in said engaging tab body, said retaining hole engaging said tab when said second engaging portion is coupled to said first engaging portion.

4. The display according to claim 3, wherein said tab is disposed parallel to said inner plate, the engagement between said second and first engaging portions restraining displacement of said base in a direction substantially perpendicular to said bottom wall of said display body and limiting leftward and rightward displacement of said base relative to said display body.

5. The display according to claim 1, wherein said display body further includes a pair of positioning holes provided in said bottom wall, said base further including a pair of guiding posts provided on said top wall of said base, said guiding posts extending respectively into said positioning holes when said base and said display body are coupled to each other.

6. The display according to claim 5, wherein said display body further includes a plurality of first locking holes provided in said bottom wall, and said base further includes a plurality of second locking holes provided in said top wall, said first locking holes and said second locking holes corresponding to each other for extension of a plurality of screws therethrough when said first engaging portion and said second engaging portion engage each other.

7. A method for assembling a display, the display including a display body and a base, the display body including a bottom wall and a first engaging portion provided on the bottom wall, the base including a top wall and a second engaging portion provided on the top wall, said method comprising:
(A) allowing the display body to lie flat;
(B) bringing the second engaging portion of the base into engagement with the first engaging portion of the display body, and causing the top wall of the base to correspond to the bottom wall of the display body; and
(C) threadedly locking the top wall of the base to the bottom wall of the display body.

8. The method according to claim 7, the first engaging portion including an opening provided in the bottom wall and a tab accessible through the opening, the second engaging portion including an engaging tab body provided on the top wall and a retaining hole provided in the engaging tab body, wherein, in step (A), a distal end of the tab is oriented upward when the display body is laid flat, and in step (B), the engaging tab body is extended into the opening, the retaining hole is brought to engage the tab, and the top wall of the base is positioned relative to the bottom wall of the display body for subsequent threaded locking there between.

9. The method according to claim 8, wherein, in step (B), when the engaging tab body is extended into the opening, the top wall of the base is displaced in a direction toward the bottom wall of the display body, and when the retaining hole engages the tab, the top wall of the base is displaced downward relative to the bottom wail of the display body.
